(19) United States
(12) Patent Application Publication
(10) Pub. No.: US 2008/0228420 A1
(43) Pub. Date: Sep. 18, 2008

(54) Web Marking Systems and Methods

(76) Inventors: Edward William Colvill, Ipswich (GB); Brendan Mark Carr, Halstead (GB)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 12/127,277

(22) Filed: May 27, 2008

Related U.S. Application Data
(63) Continuation of application No. 10/510,128, filed on Oct. 4, 2004, now abandoned.

(30) Foreign Application Priority Data
May 4, 2002 (GB) 02 07874.9

(51) Int. Cl. G06F 19/00

(52) U.S. Cl. 702/82

(57) ABSTRACT

Apparatus for and a method of marking a web 10 advancing along a path includes a monitoring station 11 at which the web 10 is observed and including a signal generator arranged to produce an appropriate mark signal on detecting a location to be marked as well as the nature of the required mark. A tab applicator 20 is disposed downstream of the monitoring station for applying an adhesive tab 34 to the web in a timed relationship to the advancement of the web so as to adhere the tab 34 to the required location on the web. The tab applicator includes an online printer receiving a signal from the signal generator, whereby an applied tab may carry appropriate indicia for the location being marked.

This invention relates to a marking system for a web advancing along a path, and also to a method of marking such a web.

Many industrial processes employ stock materials in web form, the web being advanced along a path to allow the required processing. For example, in the printing industry, a web of paper may be supplied in roll form and the web is drawn from the roll as the paper printing progresses, whereafter the web is cut into separate printed sheets. In the textile industry, many fabrics are manufactured in the form of an elongate web which is then spooled before being supplied to a garment manufacturer, for making up, or to a printer for the printing of a suitable design or pattern on to the fabric.

As manufactured, many webs of stock materials include defects. These defects might include a splice undertaken at the time of manufacture, to allow continuous manufacturing processes to operate, defects in the width of the web or in the thickness of the material, or variations in quality along the length of the web. Depending upon the particular web, many other kinds of defect may be present, but which cannot be allowed to pass through to a finished product manufactured from the material of the web.

In order to eliminate the likelihood of such a defect passing through a processing stage to a finished product, it is known to observe the web as it is despooled, and then to mark an area which must be cut out, so as not to be used in a processing operation performed on the web, downstream of the observation station. Alternatively, after manufacturing a web or performing a conversion process on a web, the web may be observed for defects as it is spooled or re-spooled. Typically, a human operator might watch the web and then apply to the web a simple paper label which will be clearly visible in a subsequent process. For example, when the web is observed as it is about to be spooled or re-spooled, a brightly coloured label may be manually inserted into the spooling web to be left projecting from the side edge of the spooled web, so that it is immediately apparent the web has been labelled.

A human operator can apply a selected colour of label, depending upon the observed fault. For example, the operator can fairly easily have at least three different colours of label and then apply the appropriate label for the defect observed. Such labels could be pre-printed to have some wording indicative of the observed defect.

It is difficult for a human operator to concentrate for long periods, watching for defects in a web as it is despooled. As a consequence, equipment has been designed to look for certain kinds of defect and then to cause a label to be automatically applied to the web, by the equipment detecting the presence of a defect. For example, one proposal uses a conventional labelling machine to apply a self-adhesive label to the advancing web, using conventional labelling technology, but a disadvantage of such equipment is that the machine must be pre-charged with a particular kind of label for use during an entire despooling or spooling operation. As a consequence, only one kind of label can be applied, irrespective of the nature of the detected defect.

This invention aims at addressing the above problem, in order to allow the use of equipment which can identify different kinds of defects in an advancing web, and then appropriately to mark the web to indicate not just where the defect is, but also what kind of defect is present.

According to one aspect of the present invention, there is provided a marking system for a web advancing along a path, comprising:
a monitoring station at which the web advancing along said path is observed;
mark signal means arranged to produce an appropriate mark signal on detection of a location to be marked and the nature of the required mark;
a tab applicator disposed downstream of the monitoring station and arranged to apply an adhesive tab to the web at the detected location, the tab inserter including an on-line printer for printing indicia on to each tab before the tab is applied to the web; and
control means receiving the mark signal from the mark signal means and driving the on-line printer and the tab applicator in a timed relationship to the advancement of the web whereby each tab is positioned at the detected location and carries appropriate indicia for that location.

According to a second but closely related aspect of this invention, there is provided a method of marking a web advancing along a path, which method comprises:
monitoring the web as it passes through a monitoring station provided on said path and producing a mark signal on detection of a location on the web to be marked, the mark signal including information about the nature of the required mark;
feeding the mark signal to control means which provides a drive signal for an on-line printer and a tab applicator provided downstream of the monitoring station, the drive signal being provided in a timed relationship to the advancement of the web; and
using the drive signal to print an adhesive tab with the on-line printer so that the tab carries appropriate indicia for the required mark and thereafter applying the tab to the web, whereby each applied tab is positioned at the noted location and carries appropriate indicia for that location.

With the marking system and method of this invention, it becomes possible to identify the nature of a defect noted as being present in an advancing web. The defect is flagged up by attaching to the web an adhesive tab in the vicinity of the defect, but the tab is printed immediately before application with suitable indicia in order to identify the nature of the defect. This allows more effective operation of a process performed on the web downstream of the marking station, and permits a decision to be made at some point subsequently as to whether the defect may be ignored, or whether that part of the web must be eliminated from the processing. A further possibility is for the beginning and end points of a defect to be appropriately marked in the event that there is an elongate section of the web which should be eliminated from the processing.

Preferably, the tab applicator includes a labelling head adapted to apply tabs to the web, each tab being in the form of a self-adhesive label. Such a labelling head may include at least one air-jet nozzle appropriately disposed to direct a jet of air on to a tab discharged from the labelling head and so to apply that tab to the advancing web. By suitable adjustment of the timing, tabs may be applied transversely to the direction of advancement of a web, even when the web has a relatively high linear speed of advancement. In this way, each tab may be left projecting from the edge of the web. In this case, it is preferred for each label to carry adhesive on only that part which adheres to the web, the projecting part of the label being free of adhesive, though for handling purposes a strip of adhesive may be present on that projecting part.

The in-line printer advantageously is arranged to allow the printing of alphanumeric characters on to each tab. For example, by printing three separate characters, a very large number of different marks may be given, or each mark may be in the form of a mnemonic for a particular kind of defect. Such a printer may comprise one of a dot-matrix print head, a thermal transfer print head or even a direct thermal print head but in the latter case each tab must be of a thermally-responsive material in order to allow the thermal print head to print markings on to the tab.

Preferably, the tab applicator is arranged to advance the next tab to be applied initially at a low speed while printing takes place and then at a high speed and then to apply a printed tab to the advancing web, at the required location. Such operation is controlled by the control means, which responds to the mark signal produced by the monitoring means and also a further signal dependent upon the speed of advancement of the web such that the tab is applied to the appropriate part of the web, at which is located the noted defect. That further signal may simply be a fixed time interval calculated on the basis of a constant known web speed and the distance between the monitoring station and the tab applicator. Alternatively, the web speed could be monitored and the further signal determined dependent upon the instantaneous web speed.

Monitoring means may be provided at the monitoring station, configured to suit the defect or defects which are to be detected. For example, the monitoring means may include a splice detector adapted to monitor for a step in the thickness of the web, or to monitor for a step-change in the light-transmissivity properties of the web. Other defects may be monitored using a video camera looking at the surface of the web, for imperfections in that surface. The output of the monitoring means is provided to the control means and which then appropriately operates the tab applicator including the in-line printer, to ensure the correctly identified tab is applied at the correct location.

By way of example only, one specific embodiment of this invention will now be described in detail, reference being made to the accompanying drawings in which:—

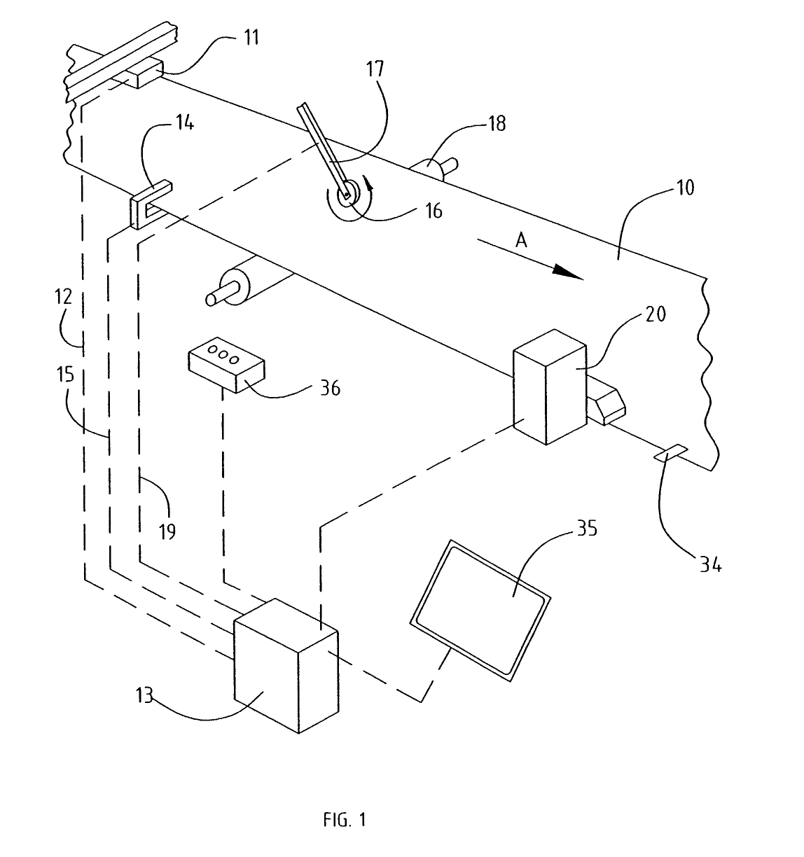

FIG. 1 diagrammatically illustrates the embodiment of marking system;

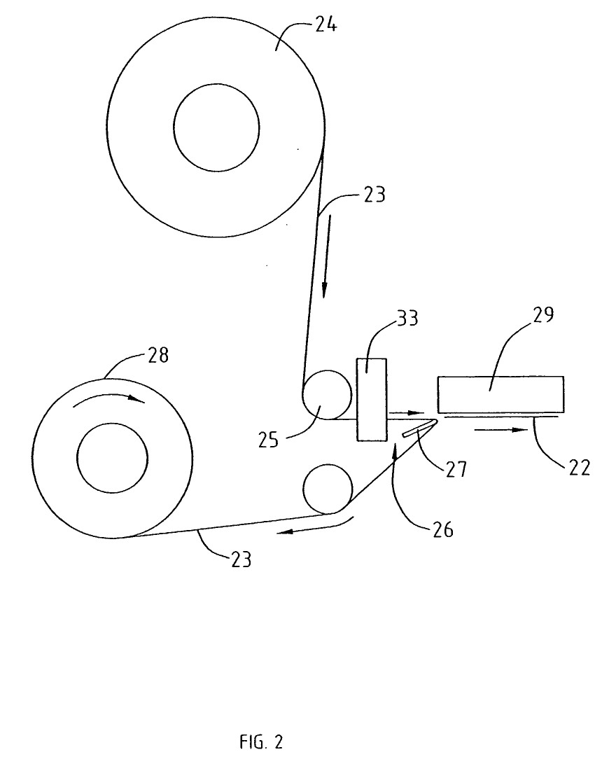

FIG. 2 is a diagrammatic side view of the tab applicator used in the marking system of FIG. 1;

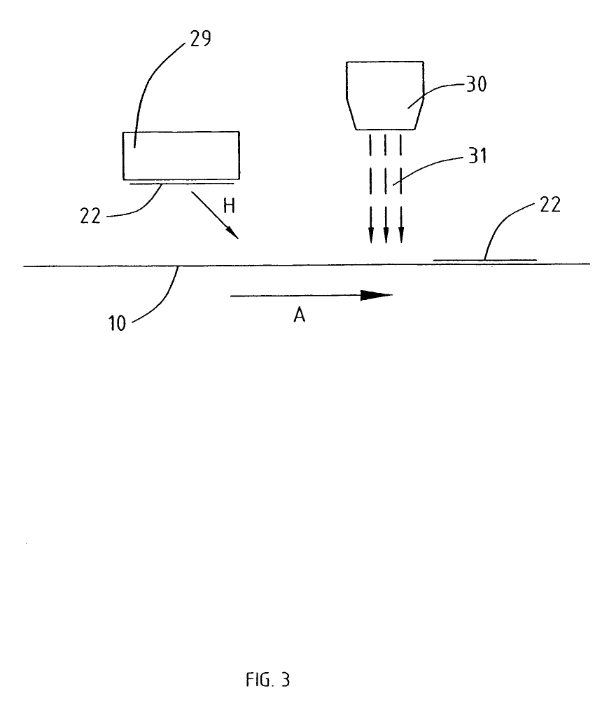

FIG. 3 illustrates the application of a tab to an advancing web; and

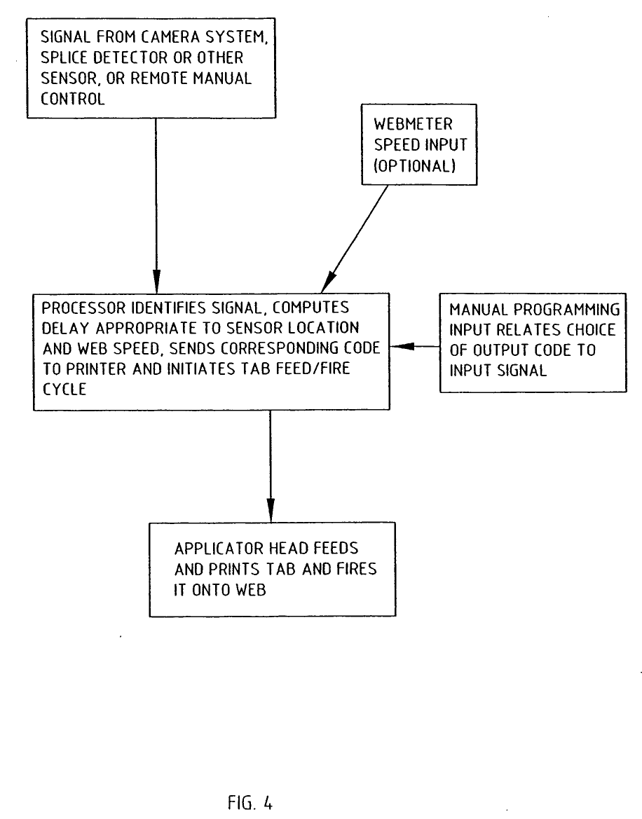

FIG. 4 is a simplified flow chart of the processing for marking a web at a noted defect.

Referring initially to FIG. 1, the marking system for a web 10, for example of paper, being advanced along a path A includes a scanning video camera 11 looking at the upper surface of the web and producing an output signal 12 to a control arrangement 13. A splice detector 14 has two opposed arms arranged one each side of the edge margin of the web 10 and monitors the transmissivity of the web; in the event that a splice passes through the detector 14, the transmissivity is briefly much reduced and a corresponding signal 15 is sent to the control arrangement 13.

The speed of advancement of the web 10 is monitored by a speed sensing wheel 16 carried by an arm 17 so as to bear on the web, in opposition to a guide roller 18. The speed sensing wheel 16 provides to the control arrangement 13 a pulsed signal the frequency of which depends upon the speed of advancement of the web.

The control arrangement 13 analyses the signals 12 and 15 respectively from the video camera 11 and the splice detector 14, to determine whether a mark need be applied to the web. If so, and in a timed relation to the advancement of the web using the signal from the speed sensing wheel 16, an appropriate drive signal 19 is sent to a tab applicator 20, downstream of the speed sensing wheel 16.

The tab applicator 20 is shown in more detail in FIG. 2. A series of tabs 22, each in the form of a self-adhesive label carried on a web of backing paper 23 is drawn from a reel 24 and guided around roller 25 to a labelling head 26 from which tabs 22 are dispensed one at a time, as the backing paper is bent round a stripping beak 27. The backing paper, on being stripped of the tabs 22, is guided to a rewinding reel 28, for subsequent disposal. Each tab, on leaving the backing paper, is collected by a vacuum foot 29, ready for dispensing on to the web 10 at the appropriate moment, in response to a signal from the control arrangement 13. That signal causes the vacuum to be released from foot 29 and instead to supply air under pressure to the foot 29, so jets of air issue therefrom to blow the tab towards the web. Disposed adjacent the vacuum foot 29 is an air jet head 30, which directs jets 31 of air on to the upper surface of a tab released from the vacuum foot 29, as the tab follows path H, to thrust the released tab into engagement with the advancing web, as shown in FIG. 3.

The tab applicator includes an in-line printer 33, disposed between the roller 25 and the stripping beak 27, to print on to the next tab to be projected an appropriate marking or indicia, for the nature of the defect noted by the video camera 11 or the splice detector 14. Typically, the in-line printer may print a group of three adjacent alphanumeric characters which will give sufficient flexibility to note a wide range of defects. Though various forms of in-line printer may be employed, preferably the printer is a direct thermal or a thermal transfer printer, arranged to transfer ink from a thermal transfer ribbon to a plain-paper self-adhesive label.

As shown in FIG. 4, the control arrangement operates the tab applicator in a timed relationship to the advancement of the web and controls the printer, to print the required alphanumeric characters for the noted defect. On recognising that a mark is to be applied to the web, and after a calculated delay based on the output from the speed sensing wheel 16, the control arrangement 13 will drive the tab applicator relatively slowly to permit printing of the required marking on to the next tab to issue from the applicator. The applicator continues to advance the backing sheet until the printed tab has been received on to the under-surface of the vacuum foot 29. At the required moment, having regard to the advancement of the web, the vacuum is disconnected from the foot 29 and instead air under pressure is supplied thereto, so releasing the tab from the vacuum foot 29 and blowing it along path H. The tab is thrust on to the web by further jets of air timed to issue from the air jet head 30. A tab applied in this way is shown at 34, in FIG. 1.

The control arrangement 13 includes a display panel 35 which conveniently takes the form of a colour LCD touch display, to facilitate the input of information by an operator. In addition, or separately, a remote control panel 36 may be provided, communicating through an umbilical cord to the control arrangement 13 or perhaps by an infra-red or wireless link. This permits the operator to make manual marks where required, or to change the output codes to be printed, dependent upon the nature of a detected defect.

1. A marking system for a web advancing along a path, comprising:
a monitoring station at which the web advancing along said path is observed;
mark signal means arranged to produce an appropriate mark signal on detection of a location to be marked and the nature of the required mark;
a tab applicator disposed downstream of the monitoring station and arranged to apply an adhesive tab to the web at the detected location, the tab inserter including an on-line printer for printing indicia on to each tab before the tab is applied to the web; and
control means receiving the mark signal from the mark signal means and driving the on-line printer and the tab applicator in a timed relationship to the advancement of the web whereby each tab is positioned at the detected location and carries appropriate indicia for that location.

2. A marking system as claimed in claim 1, wherein the tab applicator includes a labeling head adapted to apply tabs each in the form of a self-adhesive label to the web.

3. A marking system as claimed in claim 2, wherein the labelling head is provided with a vacuum foot which collects a printed tab and holds the tab until the detected location to be marked is therebelow.

4. A marking system as claimed in claim 2, wherein the labelling head includes at least one air-jet nozzle air issuing from which serves to thrust a tab discharged from the labelling head on to the web.

5. A marking system as claimed in claim 4, wherein an air controller is provided to cause air to issue from the at least one air jet nozzle only when a tab is released from the vacuum foot, to be applied to the web.

6. A marking system as claimed in claim 1, wherein the on-line printer comprises one of a dot-matrix print-head, a thermal print head or a thermal transfer print head.

7. A marking system as claimed in claim 1, wherein the tab applicator is arranged to advance the next tab to be applied initially at a low speed while printing takes place, the tab applicator then applying the printed tab at a relatively high speed to the advancing web, at the detected location.

8. A marking system as claimed in claim 7, wherein each tab is applied to the advancing web in a direction generally transverse to the direction of advancement of the web.

9. A marking system as claimed in claim 1, wherein each tab is applied to the web so that a part of the applied tab overhangs an edge of the web.

10. A marking system as claimed in claim 1, wherein monitoring means is provided at the monitoring station, said monitoring means comprising at least one of a splice detector and a web fault detector.

11. A marking system as claimed in claim 10, wherein the web fault detector includes a video camera arranged to scan the web advancing along the path and a camera output is analysed to determine the presence of one or more web defects.

12. A marking system as claimed in claim 1, wherein the control means includes a remote operation controller permitting the manual production of a mark signal on visual detection of a location to be marked.

13. A method of marking a web advancing along a path, which method comprises:
monitoring the web as it passes through a monitoring station provided on said path and producing a mark signal on detection of a location on the web to be marked, the mark signal including information about the nature of the required mark;
feeding the mark signal to control means which provides a drive signal for an on-line printer and a tab applicator provided downstream of the monitoring station, the drive signal being provided in a timed relationship to the advancement of the web; and
using the drive signal to print an adhesive tab with the on-line printer so that the tab carries appropriate indicia for the required mark and thereafter applying the tab to the web, whereby each applied tab is positioned at the noted location and carries appropriate indicia for that location.

14. A method as claimed in claim 13, wherein the speed of advancement of the web is monitored and a speed signal produced dependant thereon, and said speed signal is supplied to the control means so that the tab may be applied to the web at the required location.

15. A method as claimed in claim 13, wherein the indicia printed on a tab comprise a group of alphanumeric characters coded having regard to the noted defect to be marked.

16. A method as claimed in claim 15, wherein a group of three alphanumeric characters is printed on each tab.

17. A method as claimed in claim 13, wherein each tab is applied in a direction transverse to the direction of advancement of the web.

18. A method as claimed in claim 17, wherein each tab is applied to the advancing web so that a part of the tab overhangs an edge of the web.

19. A marking system for a web advancing along a path, comprising:
a monitoring station at which the web advancing along the path is observed to detect defects in the web;
a mark signal device arranged to produce an appropriate mark signal on detection of a defect in the web to be marked, the mark signal corresponding to a detected location on the web to be marked and the nature of the required mark;
a tab applicator disposed downstream of the monitoring station and arranged to apply an adhesive tab to the web at the detected location, the tab applicator including an on-line printer for printing indicia on to each tab before the tab is applied to the web, said indicia being indicative of the detected defect;
a speed sensing member arranged to detect speed of advancement of the web and output a corresponding speed signal; and
a control arrangement receiving the mark signal from the mark signal device and the speed signal from the speed sensing member, said control arrangement driving the on-line printer and the tab applicator in a timed relationship to the advancement of the web whereby each tab is positioned at the detected location and carries appropriate indicia for the defect at that location.

20. A marking system for a web advancing along a path, comprising:
a monitoring station at which the web advancing along the path is observed to detect defects in the web;
a mark signal generator arranged to produce an appropriate mark signal on detection of a defect in the web to be marked, the mark signal corresponding to a detected location on the web to be marked and the nature of the required mark;
a web speed sensor arranged to detect speed of advancement of the web and output a corresponding speed signal;
an electronic controller receiving the mark signal from the mark signal generator and the speed signal from the speed sensor, and generating a tabbing signal; and
a tab applicator disposed downstream of the monitoring station and arranged to apply a tab in the form of a self-adhesive label to the web at the detected location, the tab applicator including
an on-line printer for printing indicia on to a label before said label is applied to the web, said indicia being indicative of the detected defect, and
a labeling head having a vacuum foot for collecting a printed label and holding the label until the detected location to be marked of the web is below the vacuum foot,
said tabbing signal driving the on-line printer and the labeling head in a timed relationship to advancement of the web whereby each tab carries appropriate indicia for the defect at a location to be marked and is released from the labeling head to be positioned on the web at the detected defect location.

21. A marking system as claimed in claim 20, wherein the labeling head includes at least one air jet nozzle, air issuing therefrom which serves to thrust a tab discharged from the labeling head onto the web.

22. A marking system as claimed in claim 21, wherein an air controller is provided to cause air to issue from the at least one air jet nozzle only when a tab is released from the vacuum foot, to be applied to the web.
